(19) United States
(12) Patent Application Publication
(10) Pub. No.: US 2024/0185255 A1
(43) Pub. Date: Jun. 6, 2024

(54) METHOD, SYSTEM, AND NON-TRANSITORY COMPUTER-READABLE RECORDING MEDIUM FOR RECOMMENDING PAYMENT MEANS

(71) Applicant: BANK X INC., Seoul (KR)

(72) Inventor: Seung Hon KIM, Seoul (KR)

(73) Assignee: BANK X INC., Seoul (KR)

(21) Appl. No.: 18/284,953

(22) PCT Filed: Mar. 31, 2022
(86) PCT No.: PCT/KR2022/004648

§ 371 Date: Sep. 29, 2023

(51) Int. Cl. G06Q 20/40

(52) U.S. Cl. CPC G06Q 20/405

(57) ABSTRACT

Provided is a method for recommending a payment means, including acquiring payment information of at least one payment means associated with a user, analyzing a consumption pattern of the user by referring to the acquired payment information, specifying a group associated with the user by referring to the consumption pattern, predicting a future consumption pattern of the user by referring to attributes of the specified group, and determining a payment means to be recommended to the user by referring to a result of the predicting.

### TECHNICAL FIELD

The present invention relates to a method, system, and a non-transitory computer-readable recording medium for recommending a payment means.

### BACKGROUND ART

Recently, with the increase in the number of payment means (e.g., debit cards, credit cards, etc.), the types of benefits offered by each payment means (e.g., discounts, point accumulation, etc.) are becoming increasingly diverse.

However, due to the diversity of the benefits offered by these payment means, it has become difficult for users to figure out which payment means to use to receive suitable benefits. Consequently, situations where users do not fully utilize the benefits offered by the payment means frequently arise.

To solve these problems, various technologies are currently being developed to recommend payment means that provide appropriate benefits to users. As an example of the related art, a technology for recommending a payment means to a user based on payment information of the user has been proposed.

However, in the above related art, a future consumption pattern of the user that can be predicted from a user's payment information is not reflected, and only a current consumption pattern of the user extracted from the user's payment information is reflected to determine a payment means to be recommended to the user. As a result, there was a problem that there was a high possibility that benefits to be offered to the user by the determined payment means would not be suitable for the user.

### DISCLOSURE

### Technical Problem

It is an object of the present invention to solve all of the above problems.

It is another object of the present invention to reflect both a user's current consumption pattern and future consumption pattern to determine a payment means to be recommended to the user, thereby recommending a user-customized payment means personalized for the user.

It is still another object of the present invention to provide a service for recommending a more accurate payment means by predicting a user's future consumption pattern by referring to the attributes of a group associated with the user.

It is yet another object of the present invention to automatically acquire the user's payment information to recommend a user-customized payment means, thereby addressing the asymmetry of information related to digital information vulnerable groups (e.g., the elderly), which are emerging as a major axis of consumption as the population ages.

### Technical Solution

One aspect of the present invention provides a method for recommending a payment means, which includes acquiring payment information of at least one payment means associated with a user, analyzing a consumption pattern of the user by referring to the acquired payment information, specifying a group associated with the user by referring to the consumption pattern, predicting a future consumption pattern of the user by referring to attributes of the specified group, and determining a payment means to be recommended to the user by referring to a result of the predicting.

Another aspect of the present invention provides a system for recommending a payment means, which includes an information acquisition unit configured to acquire payment information of at least one payment means associated with a user, a consumption pattern management unit configured to analyze a consumption pattern of the user by referring to the acquired payment information and specify a group associated with the user by referring to the consumption pattern, and a recommendation management unit configured to predict a future consumption pattern of the user by referring to attributes of the specified group and determine a payment means to be recommended to the user by referring to the predicted result.

Still another aspect of the present invention provides another method and system for implementing the present invention, and a non-transitory computer-readable recording medium that records a computer program for executing the method.

### Advantageous Effects

As described above, according to the present invention, it is possible to reflect both a user's current consumption pattern and future consumption pattern to determine a payment means to be recommended to the user, thereby recommending a user-customized payment means personalized for the user.

In addition, according to the present invention, it is possible to provide a service for recommending a more accurate payment means by predicting a user's future consumption pattern by referring to the attributes of a group associated with the user.

Furthermore, according to the present invention, it is possible to automatically acquire a user's payment information to recommend a user-customized payment means, thereby addressing the asymmetry of information related to digital information vulnerable groups (e.g., the elderly), which are emerging as a major axis of consumption as the population ages.

### DESCRIPTION OF DRAWINGS

FIG. 1 is a diagram illustrating a schematic configuration of an entire system for recommending a payment means according to an embodiment of the present invention.

FIG. 2 is a diagram illustrating in detail an internal configuration of the system for recommending a payment means according to an embodiment of the present invention.

### DESCRIPTION OF REFERENCE NUMERALS

100: Communication network
200: Payment means recommendation system
210: Information acquisition unit
220: Consumption pattern management unit
230: Recommendation management unit
240: Communication unit
250: Control unit
300: Device

### MODES OF THE INVENTION

The detailed description of the present invention is described below with reference to the accompanying drawings, which illustrate, by way of illustration, specific embodiments in which the invention may be implemented. These embodiments are described in sufficient detail for those skilled in the art to practice the invention. It should be understood that the various embodiments of the present invention are different but need not be mutually exclusive. For example, certain features, structures, and features described herein may be implemented in other embodiments without departing from the spirit and scope of the invention by making changes in one embodiment. Furthermore, it should be understood that the location or arrangement of individual components within each of the disclosed embodiments may be altered without departing from the spirit and scope of the invention. Accordingly, the following detailed description is not intended to be taken in a limiting sense, and the scope of the present invention should be construed as encompassing the scope claimed by the appended claims together with all ranges equivalent to those claims. Like reference numbers in the figures refer to the same or similar components across several aspects.

Hereinafter, in order to enable those skilled in the art to which the present invention belongs to readily practice the present invention, preferred embodiments of the present invention will be described in detail with reference to the accompanying drawings.

### Configuration of Entire System

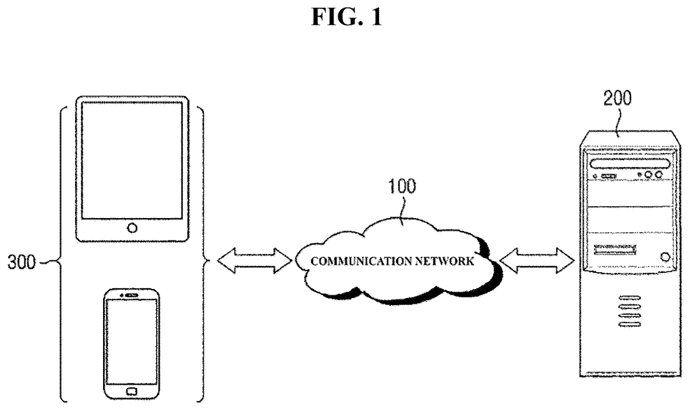

FIG. 1 is a diagram illustrating a schematic configuration of an entire system for recommending a payment means according to an embodiment of the present invention.

As illustrated in FIG. 1, the entire system according to the embodiment of the present invention may include a communication network 100, a payment means recommendation system 200, and a device 300.

First, the communication network 100 according to the embodiment of the present invention may be composed of various communication networks such as a local area network (LAN), a metropolitan area network (LAN), a wide area network (WAN), and the like, regardless of communication type such as wired communication or wireless communication. Preferably, the communication network 100 described in this specification may be the known Internet or world wide web (WWW). However, the communication network 100 is not necessarily limited thereto, and may partially include a known wired or wireless data communication network, a known telephone network, or a known wired and wireless television communication network.

Next, the payment means recommendation system 200 according to the embodiment of the present invention may perform functions of acquiring payment information of at least one payment means associated with a user, analyzing a consumption pattern of the user by referring to the acquired payment information, specifying a group associated with the user by referring to the consumption pattern, and predicting a future consumption pattern of the user by referring to attributes of the specified group and determining a payment means to be recommended to the user by referring to a result of the predicting.

The configuration and function of the payment means recommendation system 200 according to the embodiment of the present invention will be discussed in detail through the detailed description below.

Next, the device 300 according to the embodiment of the present invention is a digital device that can be connected to the payment means recommendation system 200 to perform communication. As long as the device 300 is a digital device that includes a memory device and is equipped with a microprocessor to have computing power, such as a smartphone, a tablet, a smart watch, a smart band, smart glasses, a desktop computer, a laptop computer, a workstation, a personal digital assistant (PDA), a web pad, a mobile phone, etc., the corresponding digital device can be adopted as the device 300 according to the present invention.

In particular, the device 300 may include applications (not shown) that support the user to receive services according to the present invention from the payment means recommendation system 200. Such applications may be downloaded from the payment means recommendation system 200 or an external application distribution server (not shown). Meanwhile, the nature of these applications may be generally similar to those of an information acquisition unit 210, a consumption pattern management unit 220, a recommendation management unit 230, a communication unit 240, and a control unit 250 of the payment means recommendation system 200, which will be described below. Here, at least some of the applications may be replaced with a hardware device or firmware device that can perform substantially the same or equivalent functions as necessary.

### Configuration of Payment Means Recommendation System

Hereinafter, the internal configuration of the payment means recommendation system 200 and the function of each component thereof, which performs important functions for implementing the present invention, will be described.

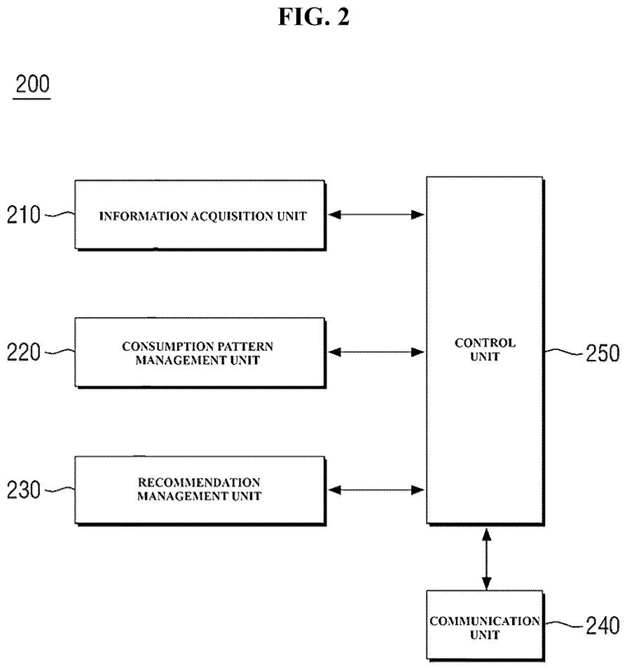

FIG. 2 is a diagram illustrating in detail an internal configuration of a system for recommending a payment means according to an embodiment of the present invention.

As illustrated in FIG. 2, the payment means recommendation system 200 according to the embodiment of the present invention may include an information acquisition unit 210, a consumption pattern management unit 220, a recommendation management unit 230, a communication unit 240, and a control unit 250. According to an embodiment of the present invention, at least some of the information acquisition unit 210, the consumption pattern management unit 220, the recommendation management unit 230, the communication unit 240, and the control unit 250 of the payment means recommendation system 200 may be program modules that communicate with an external system (not shown). These program modules may be included in the payment means recommendation system 200 in the form of an operating system, an application module, or another program module, and may be physically stored in various known memory devices. In addition, these program modules may be stored in a remote memory device capable of communicating with the payment means recommendation system 200. Meanwhile, these program modules include routines, subroutines, programs, objects, components, data structures, etc., that perform specific tasks or execute specific abstract data types, which will be described later according to the present invention, but are not limited thereto.

Meanwhile, although the payment means recommendation system 200 has been described above, this description is illustrative. It is obvious to those skilled in the art that at least some of the components or functions of the payment means recommendation system 200 may be implemented within the device 300 or a server (not shown) or included in an external system (not shown), as needed.

First, the information acquisition unit 210 according to the embodiment of the present invention may perform a function of acquiring payment information of at least one payment means associated with the user.

Here, the payment means according to the embodiment of the present invention is a payment means that can provide certain benefits such as discounts, savings, additional services, voucher provision, etc., and may include, for example, check cards, credit cards, app cards, mobile cards, simple payment means (e.g., Naver Pay, Kakao Pay, etc.), etc. In addition, the payment information of the payment means according to the embodiment of the present invention may include the name of the payment means, the identification number of the payment means (e.g., credit card number), the time of payment, the paid for consumption items, and the payment method (e.g., lump sum payment, installment, etc.), payment location (e.g., name, business type, or address), payment amount, etc.

Specifically, the information acquisition unit 210 according to the embodiment of the present invention may acquire payment information of at least one payment means associated with the user (e.g., owned by the user) by referring to at least one of information acquired from the user's device 300 and information acquired (e.g., acquired using Open API, scraping technology, etc.) from an external server (e.g., a server associated with the entity providing the payment means). For example, the information acquisition unit 210 may acquire payment information of the at least one payment means based on message information (e.g., message information about payment details), email information, location information (e.g., GPS information), voice information, call information, social network service (SNS) usage information of the user's device 300, and the like.

In addition, the information acquisition unit 210 according to the embodiment of the present invention may acquire information about the benefits of the payment means by referring to at least one of the information acquired from the user's device 300 and the information acquired from the external server. Here, the payment means is at least one payment means provided by an entity (e.g., a financial company) that provides the payment means, and may include both a payment means that is owned by the user and a payment means that is not owned by the user. In addition, the information about the benefits of the payment means may include the types of benefits provided by the payment means (e.g., promotions, affiliate brand discounts, coupons, etc.), the conditions for receiving the benefits (e.g., previous month's performance), benefit limits, installment interest rates, and the like. In addition, the information acquisition unit 210 according to an embodiment of the present invention may acquire various pieces of financial information including the user's personal information by referring to the at least one of the information acquired from the user's device 300 and the information acquired from the external server.

Next, the consumption pattern management unit 220 according to the embodiment of the present invention may analyze a consumption pattern of the user by referring to the above-described payment information acquired by the information acquisition unit 210, and specify a group associated with the user by referring to the analyzed consumption pattern.

Specifically, the consumption pattern management unit 220 according to the embodiment of the present invention may analyze the user's consumption pattern by inputting the payment information into a clustering algorithm based on unsupervised learning, and group the user and other users as the analysis result to derive at least one group (e.g., cluster) consisting of at least one user sharing the attributes of the at least one group. The consumption pattern management unit 220 according to an embodiment of the present invention may specify a group (e.g., including the user) associated with the user among the derived at least one group.

More specifically, the clustering algorithm based on unsupervised learning according to the embodiment of the present invention may be a density-based spatial clustering of applications with a noise (DBSCAN) algorithm. Since the DBSCAN algorithm does not require the number of groups to be defined in advance, it is possible to perform non-linear clustering (e.g., obtain a group of non-linear boundaries for a data set with a geometric distribution). Since the payment information acquired by the information acquisition unit 210 according to the embodiment of the present invention includes various pieces of information, it is highly likely that the payment information is formed in a geometric distribution. Therefore, the DBSCAN algorithm may correspond to an optimal algorithm for specifying the group associated with the user using the above payment information as input data.

However, the clustering algorithm based on unsupervised learning according to the embodiment of the present invention is not necessarily limited to the DBSCAN algorithm, and it should be noted that various clustering algorithms such as a K-means clustering algorithm, a hierarchical clustering algorithm, and an agglomerative clustering algorithm may be used within the scope of achieving the purpose of the present invention. In addition, it should be noted that the clustering algorithm based on unsupervised learning according to an embodiment of the present invention may be modified (or updated) by referring to a performance evaluation index (e.g., adjusted Rand index {ARI}, etc.).

In addition, the algorithm used by the consumption pattern management unit 220 according to the embodiment of the present invention is not necessarily limited to the clustering algorithm based on unsupervised learning. It should be noted that at least one of algorithms based on supervised learning (e.g., classification algorithm, etc.) and other algorithms based on unsupervised learning (e.g., principal component analysis {PCA} algorithm) may be combined with the clustering algorithm based on unsupervised learning to be used within the scope of achieving the purpose of the present invention.

In addition, it should be noted that the algorithm used by the consumption pattern management unit 220 according to the embodiment of the present invention is not limited to the algorithms listed above, and various algorithms based on machine learning or deep learning may be used within the scope of achieving the purpose of the present invention.

Next, the recommendation management unit 230 according to the embodiment of the present invention may predict a future consumption pattern of the user by referring to the attributes of the group specified as the group associated with the user, and determine the payment means to be recommended to the user by referring to the predicted result.

Specifically, according to an embodiment of the present invention, the user included in the specified group as the group associated with the user and other users (hereinafter referred to as “reference target users”) may share certain attributes. Here, the certain attributes may include at least one of attributes related to demographics and attributes related to consumption items. For example, the attributes related to demographics may include attributes related to sex, age, marital status, occupation, residence, education, disposable income, homeownership, insurance premiums, property taxes, etc. In addition, the attributes related to the consumption items may be attributes related to weighted consumption items (e.g., newly added consumption items among a plurality of consumption items paid for with the payment means) among the consumption items extracted from the payment information.

For example, according to an embodiment of the present invention, when the user is a married woman in her early thirties and newly consumes items related to childcare items, the user may be grouped with reference target users who share the attributes related to the demographics (early thirties, married, and female) and the attributes related to the consumption items (parenting items). The recommendation management unit 230 according to an embodiment of the present invention may predict the user's future consumption pattern by referring to the consumption pattern (e.g., the store that a married woman in her early thirties visits to purchase items related to childcare, the number of times she purchases the items related to childcare, the amount of money spent on the childcare items, etc.) of the reference target users. For example, the recommendation management unit 230 may predict that the user will purchase products related to childcare items worth a total of 400,000 won three times at a large supermarket. The recommendation management unit 230 according to an embodiment of the present invention may determine a payment means capable of providing optimal benefits to the user as the payment means to be recommended to the user by referring to the user's future consumption pattern. For example, the recommendation management unit 230 according to an embodiment of the present invention may determine a payment means that provides a discount benefit at a large supermarket as the payment means to be recommended to the user, when the previous transaction amount is 300,000 won or more.

Meanwhile, the recommendation management unit 230 according to the embodiment of the present invention may determine the payment means to be recommended to the user among the payment means owned by the user, but is not necessarily limited thereto. That is, the recommendation management unit 230 may determine the payment means to be recommended to the user among payment means that the user does not own. For example, when the benefits of the payment means that the user does not possess are greater than the benefits of the payment means that the user possesses, the recommendation management unit 230 according to an embodiment of the present invention may determine the payment means to be recommended to the user among the payment means that the user does not possess. For another example, when the user does not currently have a payment means (for example, in the case of a foreigner residing in Korea who is trying to apply for issuance of a payment means in Korea for the first time), the recommendation management unit 230 according to an embodiment of the present invention may determine the payment means to be recommended to the user among the payment means that the user does not possess.

Meanwhile, the recommendation management unit 230 according to the embodiment of the present invention may perform collaborative filtering to determine the payment means to be recommended to the user.

Specifically, the recommendation management unit 230 according to the embodiment of the present invention may perform collaborative filtering on users included in the group specified as the group associated with the user and the reference target users, predict the user's future consumption pattern from the consumption pattern of the reference target users as a result of performing collaborative filtering, and determine the payment means to be recommend to the user by referring to the predicted result. Meanwhile, the collaborative filtering performed by the recommendation management unit 230 according to an embodiment of the present invention may include at least one of memory-based collaborative filtering and model-based collaborative filtering. Here, when performing the model-based collaborative filtering, the recommendation management unit 230 may use a latent factor model.

However, the recommendation system (or algorithm or model) used by the recommendation management unit 230 according to the embodiment of the present invention is not necessarily limited to the collaborative filtering, and it should be noted that various recommendation systems can be used within the scope of achieving the purpose of the present invention. For example, the recommendation management unit 230 according to the embodiment of the present invention may use a recommendation system using content-based filtering, hybrid filtering, and deep learning to address the cold start problem of collaborative filtering. Here, the content-based filtering can be implemented using TF-IDF, Word2Vec, etc.

Meanwhile, the recommendation management unit 230 according to the embodiment of the present invention may calculate the user suitability of the benefits to be provided to the user by the payment means determined to be recommended to the user.

Specifically, the recommendation management unit 230 according to the embodiment of the present invention may specify with probability (%) how suitable the benefits, which are to be provided to the user by the payment means determined to be recommended to the user, are based on the user's future consumption pattern, and provide the specified result to the user.

Next, the communication unit 240 according to the embodiment of the present invention may perform a function that enables data transmission and reception to/from the information acquisition unit 210, the consumption pattern management unit 220, and the recommendation management unit 230.

Lastly, the control unit 250 according to the embodiment of the present invention may perform a function of controlling the flow of data among the information acquisition unit 210, the consumption pattern management unit 220, the recommendation management unit 230, and the communication unit 240. That is, the control unit 250 according to the present invention may control the data flow to/from the outside of the payment means recommendation system 200 or the data flow among the components of the payment means recommendation system 200, thereby controlling the information acquisition unit 210, the consumption pattern management unit 220, the recommendation management unit 230, and the communication unit 240 to perform their own functions.

Embodiments according to the present invention described above may be implemented in the form of program instructions that may be performed through various computer components and recorded on a computer-readable recording medium. The computer-readable recording medium may include program instructions, data files, data structures, and the like, alone or in combination. Program instructions recorded on the computer-readable recording medium may be those specifically designed and configured for the present invention or those known and available to those skilled in the art of computer software. Examples of computer-readable recording media include optical recording media such as magnetic media such as hard disks, floppy disks and magnetic tapes, optical media such as CD-ROMs, DVDs, hardware devices specifically configured to store and execute program instructions such as magneto-optical media such as a floptical disk, ROMs, RAMs, flash memories, etc. Examples of program instructions include machine language code, such as that made by a compiler, as well as advanced language code that can be executed by a computer using an interpreter or the like. The hardware device may be configured to operate as one or more software modules to perform a process according to the invention, and vice versa.

While the present invention has been described above in terms of specific details such as specific components, limited embodiments and drawings, this is provided only to facilitate a more general understanding of the present invention and the present invention is not limited to the above embodiments, and those skilled in the art to which the invention belongs can make various modifications and modifications from the above description.

Accordingly, the spirit of the present invention should not be limited to the embodiments described above, and not only the scope of the following claims, but also all those equally or equally modified from the claims fall within the scope of the spirit of the present invention.

1. A method for recommending a payment means, the method comprising:
acquiring payment information of at least one payment means associated with a user;
analyzing a consumption pattern of the user by referring to the acquired payment information and specifying a group associated with the user by referring to the consumption pattern; and
predicting a future consumption pattern of the user by referring to attributes of the specified group, and determining a payment means to be recommended to the user by referring to a result of the predicting.

2. The method of claim 1, wherein the group associated with the user is specified by a clustering algorithm based on unsupervised learning.

3. The method of claim 1, wherein the attributes of the specified group includes at least one of attributes related to demographics and attributes related to consumption items.

4. The method of claim 1, wherein the determining of the payment means includes performing collaborative filtering on the user and other users included in the specified group, and determining the payment means to be recommended to the user by referring to a result of performing collaborative filtering.

5. The method of claim 1, wherein the determining of the payment means includes calculating user suitability of benefits to be provided to the user by the determined payment means.

6. A non-transitory computer-readable recording medium that records a computer program for executing the method of claim 1.

7. A system for recommending a payment means, the system comprising:
an information acquisition unit configured to acquire payment information of at least one payment means associated with a user;
a consumption pattern management unit configured to analyze a consumption pattern of the user by referring to the acquired payment information and specify a group associated with the user by referring to the consumption pattern; and
a recommendation management unit configured to predict a future consumption pattern of the user by referring to attributes of the specified group and determine a payment means to be recommended to the user by referring to the predicted result.

8. The system of claim 7, wherein the group associated with the user is specified by a clustering algorithm based on unsupervised learning.

9. The system of claim 7, wherein the attributes of the specified group includes at least one of attributes related to demographics and attributes related to consumption items.

10. The system of claim 7, wherein the recommendation management unit performs collaborative filtering on the user and other users included in the specified group, and determines the payment means to be recommended to the user by referring to a result of performing collaborative filtering.

11. The system of claim 7, wherein the recommendation management unit calculates user suitability of benefits to be provided to the user by the determined payment means.
